(19) United States
(12) Patent Application Publication
(10) Pub. No.: US 2012/0013158 A1
(43) Pub. Date: Jan. 19, 2012

(54) Portable flat seat

(76) Inventor: Deborah Randazzo, Maricopa, AZ (US)

(21) Appl. No.: 13/135,889

(22) Filed: Jul. 15, 2011

Related U.S. Application Data
(60) Provisional application No. 61/399,649, filed on Jul. 15, 2010.

(51) Int. Cl. B60N 2/24

(52) U.S. Cl. 297/256.1; 297/250.1

(57) ABSTRACT

The present invention provides a portable flat seat installed in the back of a vehicle and providing a sturdy surface. This device can provide a surface on which an animal such as a dog can sit upon and peer out and view the world outside the vehicle window. The device is also useful for supporting cargo such as groceries, or other items. Manufactured primarily of plastic or poly compound material, the flat seat is comprised of an essentially rectangular shaped platform secured to the vehicle by means of simple clips or hook fasteners. Adjustable to various widths to accommodate a variety of needs such as both large and small pets, the platform provides an ample support on which an animal can sit or cargo can be placed.

### CLAIM OF PRIORITY

This patent application claims priority under 35 USC 119 (e) (1) from U.S. Provisional Patent Application Ser. No. 61/399,649 filed Jul. 15, 2010, of common inventorship herewith entitled, “Portable Flat Seat.”

### FIELD OF THE INVENTION

This invention relates generally to the field of pet accessories, and more specifically to the field of pet accessories useful for providing an animal a flat seat installed in the back of a vehicle and providing a sturdy surface on which an animal can peer out and view the world outside the vehicle window.

### BACKGROUND OF THE INVENTION

Because dogs are more often considered a member of the family, as opposed to merely a pet, many dog owners take their dog with them when traveling away from home. Whether heading off for a quick trip to the local pet store or embarking on a cross-country family vacation, bringing along the family dog affords the loving pet owner a simple means of spending quality time with their animal.

Although there is little dispute that traveling with a pet can be enjoyable for both the animal and his or her owner, there is one significant drawback associated with this practice. Specifically, most dogs enjoy looking out the window during travel and thus rest their front paws on the window's framework in order to peer outside. Not surprisingly, should the driver take a sharp turn or make a sudden stop, the animal can easily loose their footing, falling off the seat and in some cases sustaining injury.

The prior art has put forth several designs for vehicle seat attachments for pets. Among these are:

U.S. Pat. No. 4,512,286 to Paul R. Rux describes a pet seat for automobiles comprising a harness for securing the pet in a container. The container has a hinged front wall and is adjustable to a plurality of positions to accommodate lying, sitting, or standing positions for the pet.

U.S. Pat. No. 5,479,892 to Myitis C. Edwards describes a vehicle safety seat for pets comprising four relatively low walls about a central seating area, with the walls extending upward from a storage compartment situated below a removable pet seating floor.

U.S. Pat. No. 7,717,062 to Nancy Kline describes a pet seat arrangement comprising a container for comparatively small pets which may be detachably mounted on the console structure of a vehicle.

None of the prior art references describes the present invention.

### BRIEF DESCRIPTION OF THE DRAWINGS

FIG. 1 is a front perspective view illustrating the device of the present invention in place on the rear seat of an automobile.

FIG. 2 is a close up front perspective view of the device of the present invention in place on the rear seat of an automobile showing the mounting to the rear of the front seat and the adjustability of the size of the seating platform.

### DETAILED DESCRIPTION OF THE INVENTION

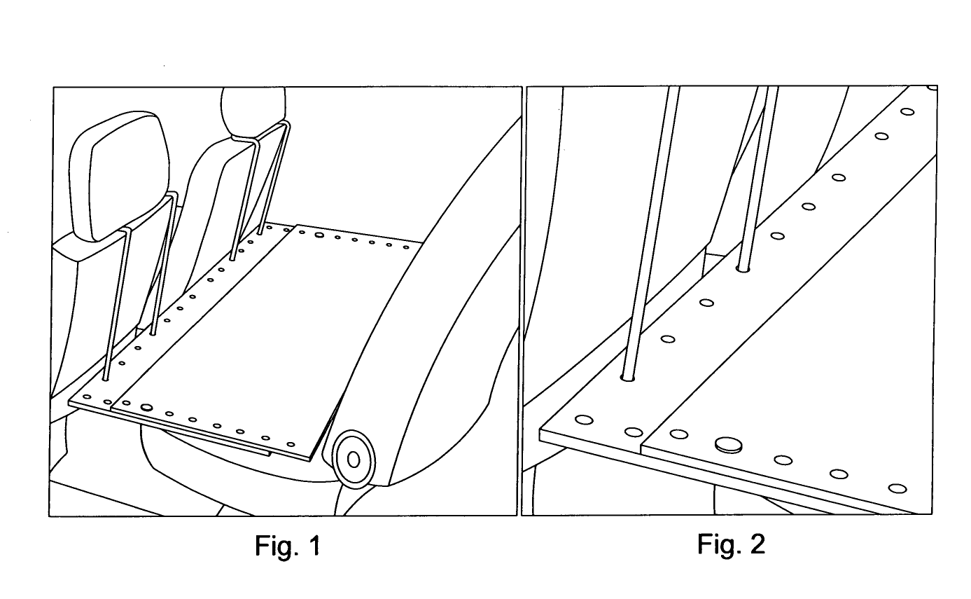

As illustrated in FIGS. 1 and 2, the present invention is a portable flat seat installed in the back of a vehicle and providing a sturdy surface. This device can provide a surface on which an animal such as a dog can sit upon and peer out and view the world outside the vehicle window. The device is also useful for supporting cargo such as groceries, or other items. Manufactured primarily of plastic or poly compound material, the flat seat is comprised of an essentially rectangular shaped platform secured to the vehicle by means of simple clips or hook fasteners. Adjustable to various widths to accommodate a variety of needs such as both large and small pets, the platform provides an ample support on which an animal can sit or cargo can be placed. As an additional consideration, the surface of the platform can be coated in grooved rubber, carpet, or similar cushiony soft, nonskid material. Further, the flat seat can be produced in a range of attractive colors such as black, tan, gray, and blue to match various vehicle interiors, as well as in a variety of bright hues or printed designs.

In an embodiment, the portable flat seat of the present invention spans the entire width of the back seat of a vehicle.

The portable flat seat of the present invention offers pet and vehicle owners a number of significant benefits and advantages. Foremost, the flat seat provides animal lovers a simple means of safely traveling with their animal. The flat seat also provides vehicle owners a convenient platform on which to place cargo. Users will appreciate that the platform provides their dog a stable support on which to peer out the window and enjoy their surroundings. As such, the portable flat seat encourages the animal to remain seated, as opposed to freely roaming around the vehicle when the vehicle is in motion. The Portable Flat Seat also closes the gap between the back of the front seat and the back seat, providing a safe place for animals to lie or sit without worry that the pet would fall between the seats or become stuck while resting or sleeping. Easily installed utilizing simple clip or hook fasteners, the flat seat is well suited for use with virtually any make or model car of truck. Further, because the flat seat is produced in range of sizes to accommodate small, medium, and large breeds dogs, pet owners can rest assured that there is a flat seal perfectly sized for their pet. Not limited to dogs, the flat seat also provides cat owners a comfortable perch on which a beloved feline can recline during travel.

The portable flat seal of the present invention offers users a valuable safety tool when traveling with their pets. Providing a comfortable platform on which the animal could peer out the window, the flat seat proves a favorite commodity of any pet owner. The flat seat is also good when transporting your pet in a pet crate. By using the flat seat, the crate remains level for the pet and prevents the crate from sliding between the seats when the vehicle stops. Also by using the flat seat there is room at the back where the seat belt can be used to secure the pet or crate to the car seats for extra added protection.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable flat seat device comprising an essentially rectangular platform to be placed in the back seat of a vehicle to provide a surface on which an animal can sit, or cargo can be placed.

2. The portable flat seat device of claim 1 further comprising clips or hooks to fasten the platform to the back of the front seat of a vehicle.

3. The device of claim 1 manufactured primarily of plastic or poly compound material.

4. The device of claim 1 wherein the platform is adjustable to various widths to accommodate a variety of needs such as both large and small pets, and cargo.

5. The deice of claim 1 further comprising the surface of the platform coated in grooved rubber, carpet, or similar cushiony soft, nonskid material.

6. The device of claim 1 produced in a range of attractive colors such as black, tan, gray, and blue to match various vehicle interiors, as well as in a variety of bright hues or printed designs.

7. The device of claim 1 wherein the platform spans the entire width of the back seat of a vehicle.
